(19) United States
(12) Patent Application Publication
(10) Pub. No.: US 2013/0145387 A1
(43) Pub. Date: Jun. 6, 2013

(54) SYSTEM FOR OUTPUTTING A CHOICE RECOMMENDATION TO USERS

(71) Applicants: Ray Van Brandenburg, Delft (NL); Mattijs Oskar Van Deventer, Delft (NL); Peter Joannes Mathias Veugen, Delft (NL)

(72) Inventors: Ray Van Brandenburg, Delft (NL); Mattijs Oskar Van Deventer, Delft (NL); Peter Joannes Mathias Veugen, Delft (NL)

(21) Appl. No.: 13/702,035

(22) PCT Filed: Jun. 7, 2011
(86) PCT No.: PCT/NL2011/050404

§ 371 Date: Feb. 14, 2013

(30) Foreign Application Priority Data
Jun. 7, 2010 (EP) 10165126.3
Nov. 4, 2010 (EP) 10190044,7

(51) Int. Cl. H04N 21/258

(52) U.S. Cl. CPC H04N 21/25866
USPC 725/14

(57) ABSTRACT

System for outputting a choice recommendation to one or more users based on earlier choices made by them. A data record is made per choice per user, each data record including a representation of the user, a representation of the choice and a representation of any other user involved with that choice, such as other users that watched a program with the user. The data record may include a representation of the user, a representation of the choice and a representation of no more than one other user involved with that choice, where more records are made when more other users are involved. The data record may include a representation of an environment linked to the choice, e.g. of a localization and/or hardware and/or software linked to the choice. The recorded representation of other users involved with the choice, such as other users that watched a program with the user, is used later to compute the choice recommendation. A synthetic set of watching events for a detected group of users may be determined for this purpose, based on the identity of the members of the group and the representation of “watch with” users of the watching event.

### FIELD OF THE INVENTION

The invention relates to a system comprising data processing means for outputting a (choice) recommendation to one or more users based on earlier choices made by them. Such a recommendation may be related to—not exclusively, however—to TV watching, which is seen as a good application example of such system.

### BACKGROUND

In general, such systems, called recommender systems, recommendation systems or recommendation engines form or work with a specific type of information filtering system technique that attempts to recommend information items, generally referred to as “content (items)” or “programs” (films, television programs, video on demand items, music, books, news, images, web pages, etc.) that are likely to be of interest to the user. Typically, a recommender system compares a user profile to some reference characteristics, and seeks to predict the ‘rating’ that users would give to a content item they had not yet considered. These characteristics may be derived from the information item (the content-based approach) or the user's social environment (the collaborative filtering approach).

Television—which is used in the following as an exemplary domain in which the present (kind of) system can be used—is a medium that is typically used by several people at the same time; think of family or friends who watch a TV program together at the bar at the end of the day. On the other hand, people are all different, everyone has his own preferences. Current technology (IPTV) makes it possible for several users to make and control their own personal profile with preferences. These profiles, however, do not take into account the fact that people may have different preferences and requirements when they are together in a group. When program recommendations are given for a father who watches TV together with his child, it makes no sense, for example, to allow for the father's preference for war movies. Also a married couple together would probably watch different movies than they would watch separately. There is therefore a need for a system that takes into account the idea that composite groups behave differently from each of its members separately. US 2003/237093 discloses a system which is able to determine which persons are present in a room, and to establish a joint profile made up from the individual profiles of those persons. The document proposes to detect user group changes that occur by one or more users leaving the viewing area or arriving into the viewing area. Suitable methods or systems can be utilized to ascertain whether a user leaves or arrives into the viewing area are known.

The document gives the example of use of login and logoff mechanism to detect the composition of the group of users. In another embodiment a fingerprint reader panel may be used that detects touching by the users' fingers when a user enters the viewing area. Another example is a physical push button provided on a display panel, used as a switch to indicate that the user has left the room.

Another example is a radio smartcard badge utilized to ascertain when users enter and/or leave the viewing area, or an inductive badge. The system may be configured to detect the presence of users by the presence of a transmitting transmitter carried by their badge. When the user leaves the viewing area, the system can detect the loss of the user's signal and can ascertain that the user is no longer within the area. The “badge” may comprise any suitable wearable component that can be worn by and carried around by a user. Such components can include bracelets, anklets, and other items that can be worn by the user. An inductive badge detector may be provided at the doorway. As the badge passes through the doorway, an inductive loop in the badge is able to draw power via an inductive coupling to the detector and is therefore able to transmit its user's secure identification signal.

In another example, a face recognition system may be used to detect users present in the area. The system may comprise one or more cameras to periodically monitor the entire viewing area. In another embodiment, a voice recognition system can be utilized to ascertain the identification of users within the viewing area. In accordance with another embodiment, an EPG system can be controlled and can receive input from one or more individual personal computers, such as laptop computers, tablet PCs and the like. In another embodiment each user has his or her own individual computer or computing device. In this case login of users into their own computing devices is used to determine the users that are present.

However, the system known from US 2003/237093 is based on the individual personal preferences defined without the influence of group interaction/behaviour

In order to make recommendations for a group of people a watching history of that group could be made, i.e. a record of what programs the persons of the group watched together in the past. An obvious way for doing this would be to create a profile for each group. If a group as a whole watches a program, this information is stored then in the watching history or profile of this group. If the group desires to watch TV together again at a later moment, the group's watching history/profile is used to make a recommendation for a new TV watching session. Such way of doing, however, has two great disadvantages. First, it is not flexible: when a certain subset of a group that previously watched together is watching together, a new profile has to be made, in which the information from the past cannot be included (since it now involves a subset and therefore a different group). For larger groups, the chance that the people in precisely the same composition will watch TV once more is very small. As a result, the situation arises that there are many profiles with unfortunately a very small and therefore nearly useless viewing history. A second disadvantage is that this system is not scalable. If the total number of users is N, then in the case of a group consisting of 2 persons n!/(2!*(n−2)!) profiles are needed; for a group of 3 persons n!/(3!*(n−3)!), and for a group of 4 persons n!/(4!*(n−4)!) etc.

### SUMMARY

It is an object to provide for improved recommendation system and method wherein environmental information may be used in the process for outputting a choice recommendation to one or more users.

It is an aim to take into account for the influence of the group of users that jointly watch a content item on the preferences of the individual users in that group.

A recommendation system is proposed for outputting a choice recommendation—either related to TV programs, programs like movies on DVDs etc. or to other content items—to a group of one or more users based on earlier choices made by them. Data records are made per user for previous choices, each data record including a representation of the user, a representation of the choice and a representation of any other user involved with that choice. The representation of any other user involved with that choice may represent one or more other users that the user has watched a chosen content with. This information is used to generate recommendations to account for the influence of the group on the preferences of the individual persons. For the sake of data efficiency and scalability—as will be discussed below—it may be preferred that the data record includes a representation of the user, a representation of the choice and a representation of no more than one other user involved with that choice (e.g. has watched with the user), where more records are made when more other users are involved (e.g. have watched with the user).

A method for outputting a choice recommendation, e.g. related to TV programs is provided, the method comprising
recording a watching history of users, the watching history comprising representations of watch events, the representation of a watch event for a user including information about a further user or users who with the user has jointly watched a content item;
making a recommendation for a group of users dependent on recorded joint watching of users in the group. The recommendation may be made by a processor that has access to a memory wherein data records representing the watching history are stored. For making the recommendation, the processor may detect the users in the group in any known way, such as the ways described in US 2003/237093. The representations of watch events may be recorded by a computer into a memory, upon detection of a watch event. Also in this case, the computer may determine joint watching users involved with this watch event based on detection of users that may be performed in any known way, such as the ways described in US 2003/237093.

In an embodiment the method comprises
receiving a request for the recommendation for a group of users;
retrieving the watching history of all the users of the group;
providing the watching events in the retrieved watching histories each with a weighing factor, dependent on whether the watching event represents that at least part of the users of the group have watched jointly;
combining all weighed watching events into one common watching history;
applying the combined watching history of the weighed watching events to a recommender system;
using the recommender system to make a recommendation on the basis of the weighed watching events;
outputting the recommendation.

In this way, the use of “watched with” information for watch events can be combined with existing recommendation methods for single users. The recommender system may generate the recommendation using a collaborative filtering approach or content based approach for example, which are known per se, using the common watching history for the current group that has been synthesized in this way instead of the watching history for a predetermined (group) user. In an embodiment, the weighing actor may be binary, a non-zero or zero weight being given, i.e. the watching event being incorporated in the common watching history or not, dependent on whether the watching event indicates at least part (more than one) of the users of the group have watched jointly. The users of the group may be determined for example by identifying the users that are present when the request is received. Any known way of identifying these users may be used, such as the ways described in US 2003/237093.

In an embodiment the weighing factor includes assigning a weighing to the watching history on the basis of a binary alone/together situation, comprising
detecting whether in the present watching situation the group of users consists of one user or a plurality of users and,
in the case that the group consists of one user only watch events are considered that represent that the user has watched TV alone, or these watching events are weighed more heavily than watch events that represent that the user has watched TV with other users; and where,
in the case that the group consists of a plurality of users, watch events that represent that the user has watched TV with other users of the group are weighed more heavily.

A recommendation system for generating recommendations e.g. related to TV programs is provided, the system comprising
a memory storing data records recording a watching history of users, the watching history comprising representations of watch events for a user, the representation of a watch event including information about a user or users who with the user has jointly watched a content item;
a processor programmed to determine a recommendation for a group of users on the basis of recorded joint watching of users in the group.

According to one aspect a recommendation system is proposed for outputting a choice recommendation—either related to TV programs, DVDs etc. or to other items—to one or more users based on earlier choices made by them, wherein at least one data record is made per choice per user, each data record including a representation of the user, a representation of the choice and a representation of any other user involved with that choice. For the sake of data efficiency and scalability—as will be discussed below—it may be preferred that the data record includes a representation of the user, a representation of the choice and a representation of no more than one other user involved with that choice, where more records are made when more other users are involved.

Besides the users involved in the choice, the data record may include a representation of an environment linked to the choice. For instance, the data record may include a representation of a localization (e.g. room, geometric data etc.) linked to the choice and/or a representation of hardware and/or software linked to the choice. All those environmental information may be used in the process for outputting a choice recommendation to one or more users.

The choice (recommendation) may e.g. relate to watching a movie (including TV, DVD etc.), but also listening music, eating and/or drinking or other “activities” which can be done by a group of individual persons (users). One (commercially) interesting option is the use of the system where the recommendation made by the system is represented by an advertisement.

One aspect provides a method for outputting a choice recommendation, e.g. related to watching TV programs, to one or more users based on earlier choices made by them, wherein at least one data record is made per choice per user, each data record including a representation of the user, a representation of the choice and a representation of any other user involved with that choice.

In an embodiment, the method comprises the steps of:
a. a request is made for a recommendation;
b. the users present are identified;
c. the watching history is retrieved of all those present;
d. on the basis of one or more weighing methods the watching events in the watching histories of the users present are provided with a weighing factor;
e. all weighed watching events are combined into one common watching history;
f. the combined watching history of weighed watching events is applied to a recommender system;
g. the recommender system makes a recommendation on the basis of the weighed watching events;
h. the recommendation is output.

Additionally provides a computer program product for carrying out the method as defined above is provided. A computer program product may comprise a set of computer executable instructions stored on a tangible data carrier, such as a CD or a DVD, a magnetic disk or a semi-conductor memory for example. The set of computer executable instructions, which allow a programmable computer to carry out the method as defined above, may also be available for downloading from a remote server, for example via the Internet.

### BRIEF DESCRIPTION OF THE DRAWING

Hereinafter these and other objects and aspects will be elucidated by means of a description with reference to the following figures.

FIGS. 1a-b show two examples of a user profile with a multi-user or co-user component;

FIG. 2 shows an exemplary data model of a user profile;

FIG. 3 shows an overview of in which way multi-user user profiles may be used for performing program recommendations; and

FIG. 4 shows an exemplary protocol stack for synchronizing a local profile with a network profile.

### DETAILED DESCRIPTION OF EXEMPLARY EMBODIMENTS

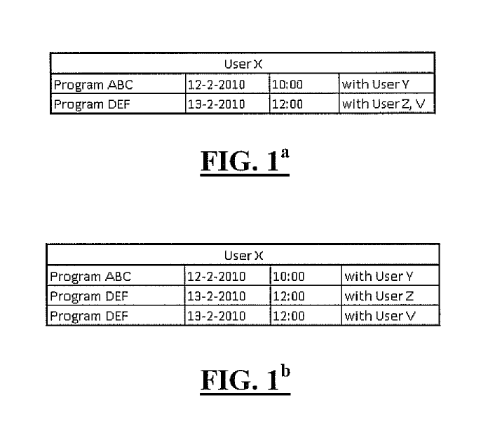

In FIG. 1 two examples are given of a user profile with a multi-user component, made for a user X. User X has watched two programs in the time elapsed. Therefore, two watching events have been registered: the first one for TV program ABC watched together with co-watcher Y, the second one for program DEF together with co-watchers Z and V. It is noted that for the identification and/or association of persons related to watching TV programs or other media content the means of identifying persons in a viewing area disclosed in from US 2003/237093 could be used, such as smart cards as known as such from US 2003/237093.

In certain cases, it may be more convenient to store a viewing event (record) with two other users (seen in FIG. 1a) than storing two separate viewing events (records) at the same time point or occurrence (seen in FIG. 1b).

By storing the viewing-together information in the standard user profiles instead of in special group profiles, this information is much more easily used and of broader applicability. The information that user X watched the program DEF together with users Z and V can be used when Z in the future watches together only with Z or only with V, with Z and V, or even with Z, V and W. Naturally, the application of the recommendations offers the choice of what information if any is to be used.

Besides information on what program is watched, it may also be of interest to store other information per viewing event. An example of this is audio/video preferences. It may be the case when one views together with a large group of people, the sound level, e.g., becomes higher.

The viewing location may also be of interest. When two persons are watching at person A's home, the context (or environment) is different, and perhaps other choices are made than when they are watching at person B's home. Here audiovisual preferences may be applied but also the type of programs (person A may live in a student house, person B together with wife and children).

Current IP based TV architectures also support the concept of watching apart together: two people may be at different locations but watch a TV program “together.” In this case, together means that they can communicate about what they are watching via an audio/video connection. For cases of this type, it is also convenient if the viewing events also support split-location viewing. For each of the co-viewers, therefore, a separate viewing location may be stored.

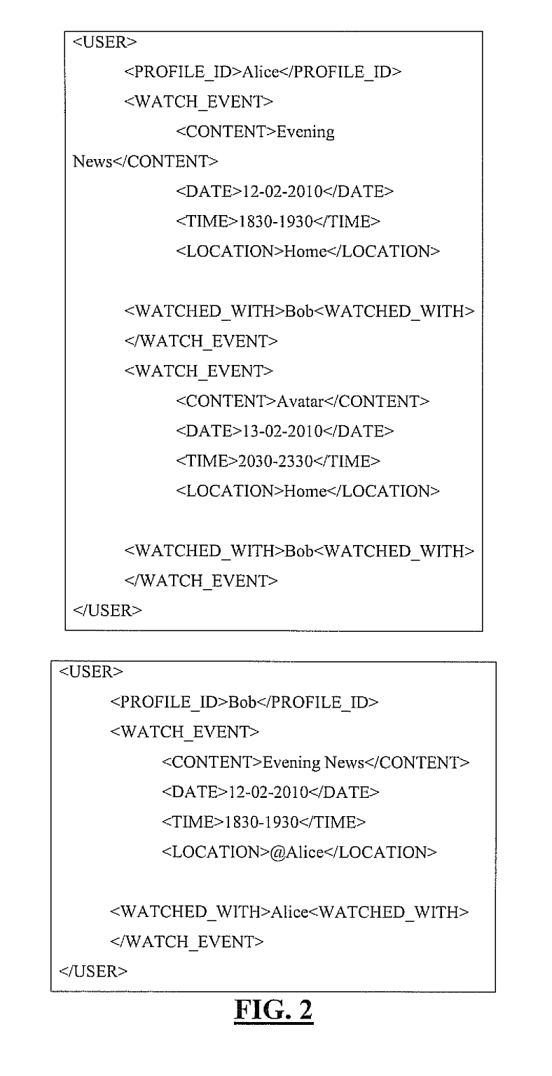

FIG. 2 shows an exemplary data model of a user profile in these cases for a user A(lice) and B(ob) respectively.

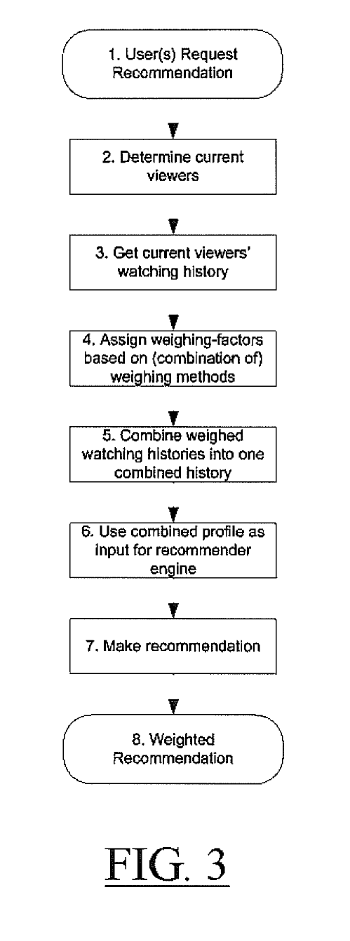

FIG. 3 shows an overview of in which way multi-user user profiles may be used for performing program recommendations:
1. A request is made for a program recommendation
2. The present users are identified (if not done already). This may e.g. be performed as disclosed in an earlier patent of Microsoft®, in US 2003/237093.
3. The watching history is retrieved of all users present.
4. On the basis of one of the four weighing methods below (or a combination of them) all watching events in the watching histories of the users present are provided with a weighing factor.
5. All weighed watching events are combined into one common watching history which is generated specifically for this situation.
6. The combined watching history of weighed watching events is applied to a recommender system (e.g. a collaborative filter).
7. The recommender system makes a recommendation on the basis of the weighed watching events.
8. The recommendation is output to e.g. the user(s).

The advantage of combining the weighed watching events into one combined watching history is that the above system can be used with all current recommender systems; the recommender itself does not see any difference between this combined multi-user watching history and a standard single-user watching history.

Below, four methods are presented, to be used for assigning weights to specific watching events, on the basis of the multi-user watching histories of the users present.

Binary Multi-User Component

The most simple way to assign a weighing to the watching history is on the basis of a binary alone/together situation. In this case, during the making of the recommendation it is detected whether the present watching situation exists from one person or from several persons. In the case that one person is watching TV, for making the recommendation, either only watching events are considered where the user watches TV alone, or these watching events are weighed more heavily. In the case that several persons watch TV, the watching together watching events are weighed more heavily.

Alice

| | | |
|---|---|---|
| 12-2-2010 20:00-20:30 | 20:00 News (news) | (alone) |
| 13-2-2010 21:30-23:30 | Spiderman (action movie) | Bob |
| 15-2-2010 20:00-23:00 | Casablanca (romantic movie) | Charlie |
| 21-2-2010 20:30-22:00 | Batman (action movie) | Bob, David |

Bob

| | | |
|---|---|---|
| 11-2-2010 13:00-14:00 | Friends (comedy) | David |
| 12-2-2010 20:00-20:30 | Stock market (financial) | (alone) |
| 13-2-2010 21:30-23:30 | Spiderman (action movie) | Alice |
| 21-2-2010 20:30-22:00 | Batman (action movie) | Alice, David |

User Overlap

A more specific way to weigh the watching history is to weigh more heavily watching events where one or several of the present watchers were also present. Suppose that e.g. Alice is going to watch TV together with Bob, then the watching events of Alice and Bob are weighed more heavily)in this case Spiderman and Batman). The watching event of Alice and Charlie (Casablanca)) is not counted more heavily while the users do not correspond here.

Alice

| | | |
|---|---|---|
| 12-2-2010 20:00-20:30 | 20:00 News (news) | (alone) |
| 13-2-2010 21:30-23:30 | Spiderman (action movie) | Bob |
| 15-2-2010 20:00-23:00 | Casablanca (romantic movie) | Charlie |
| 21-2-2010 20:30-22:00 | Batman (action movie) | Bob, David |

Bob

| | | |
|---|---|---|
| 11-2-2010 13:00-14:00 | Friends (comedy) | David |
| 12-2-2010 20:00-20:30 | Stock market (financial) | (alone) |
| 13-2-2010 21:30-23:30 | Spiderman (action movie) | Alice |
| 21-2-2010 20:30-22:00 | Batman (action movie) | Alice, David |

Paul

| | | |
|---|---|---|
| 11-2-2010 17:00-19:00 | The Big Bang Theory (comedy) | Bob |

Common Friend

The “common friend” method can be used when two users do not have a common history, but when they do have common friends. “Friends” implies in this case that users A and B watched together never before but they watched earlier together with user C. In the above example Alice and Paul e.g. never watched together earlier; however they both watched together with Bob. In this case the watching events of both Alice and Paul which include Bob, would weigh more heavily (Spiderman, Batman and The Big Bang Theory).

Comparable Relationship

The comparable relationship method makes use of the type of relations between several users, In this case the multi-user component has to have, beside information about with whom a watching event occurred, also information which relation the user has with this person. A possible source of this information could be e.g. social networks. Suppose that Alice is going to watch TV with her colleague Ethan with whom she never watched TV before. In this case watching events between Alice and Bob might going to weigh more heavily, as the relation between Alice and Bob is comparable with the relation between Alice and Ethan (both colleagues).

Alice

| | | |
|---|---|---|
| 12-2-2010 20:00-20:30 | 20:00 News (news) | (alone) |
| 13-2-2010 21:30-23:30 | Spiderman (action movie) | Bob (colleague) |
| 15-2-2010 20:00-23:00 | Casablanca (romantic movie) | Charlie (in a |
| | | relationship) |
| 21-2-2010 20:30-22:00 | Batman (action movie) | Bob (colleague), |
| | | David (friend) |

Bob

| | | |
|---|---|---|
| 11-2-2010 13:00-14:00 | Friends (comedy) | David (friend) |
| 12-2-2010 20:00-20:30 | Stock market (financial) | (alone) |
| 13-2-2010 21:30-23:30 | Spiderman (action movie) | Alice (colleague) |
| 21-2-2010 20:30-22:00 | Batman (action movie) | Alice (colleague), |
| | | David (friend) |

Finally, it is noted that when two users watched a program together, this watching event thus has to be stored into two profiles. This requires some form of synchronization. Dependent of where profile information is stored (locally/centrally) this synchronization can have different forms.

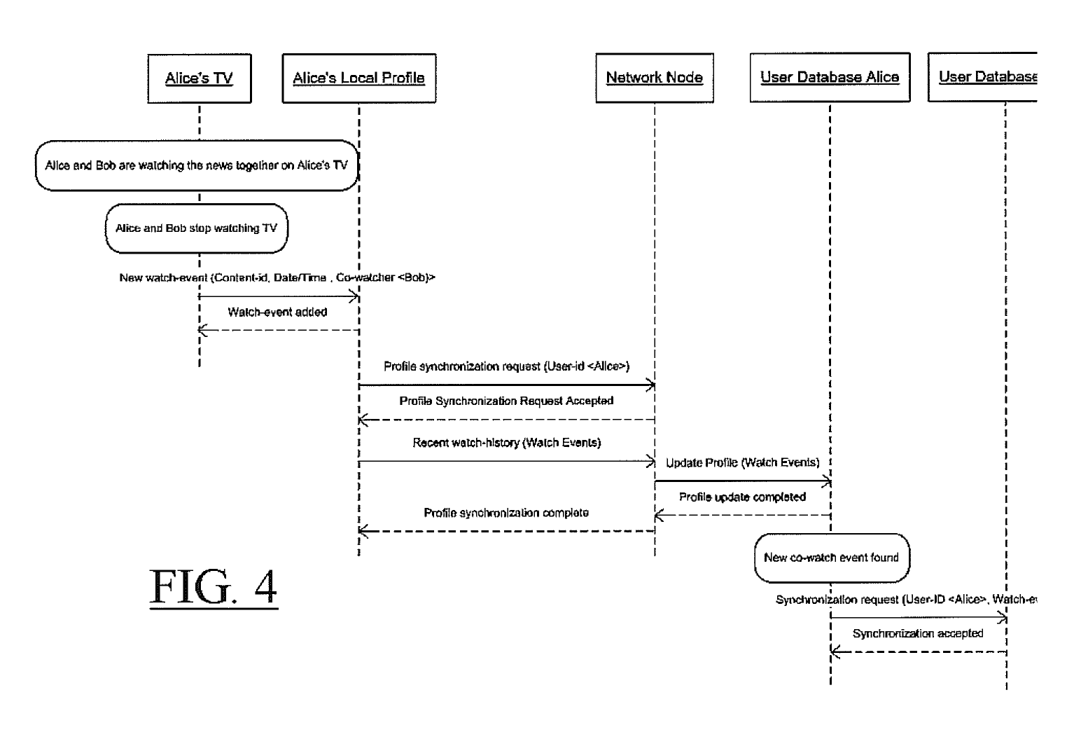

FIG. 4 shows how this could work in the case of a local profile that is periodically synchronized with a network profile. A similar situation can take place in which all profiles are stored locally and, e.g., a synchronization action has to be performed with the Bob's TV or even with a mobile device (RFID tag, mobile phone).

A recommendation system may be constituted by a central unit, such as a suitably programmed personal computer, and user terminals. The central unit and the user terminals are suitably connected via the internet or other means. The central unit, which contains a processor configured for running a software program stored in a memory coupled to the processor, comprises a choice recommendation output unit configured for outputting recommendations to one or more users, which recommendations are based on earlier choices made by those users. The central unit is further configured for making at least one data record per choice and per user, each data record including at least a representation of the user, a representation of the choice and a representation of any other user involved with that choice. The data records thus made may also be stored in the memory mentioned above. The choice recommendation output unit may be at least partially constituted by a suitable software program or software program unit, which can be executed by the processor referred to above, but at least part of the choice recommendation output unit may be implemented in hardware. The user terminals, which may be constituted by mobile (that is, cellular) telephone units, comprise a keypad and/or a suitably configured touch-screen for entering selection information. The user terminals may, alternatively or additionally, be configured for speech recognition. In some embodiments, the user terminals may be absent and the central unit is connected to the television set and/or personal computer (or any combined viewing unit) of each user so as to gather user preference (that is, choice) information. Those skilled in the art will be able to design alternative embodiments of the recommendation system.

A recommendation system is provided that comprises means for outputting a choice recommendation to one or more users based on earlier choices made by them, wherein at least one data record is made per choice per user, each data record including a representation of the user, a representation of the choice and a representation of any other user involved with that choice.

In an embodiment wherein the data record includes a representation of the user, a representation of the choice and a representation of no more than one other user involved with that choice, where more records are made when more other users are involved. The data record may include a representation of an environment linked to the choice. In a further embodiment the data record includes a representation of a localization linked to the choice.

In an embodiment, the data record includes a representation of hardware and/or software linked to the choice. In an embodiment wherein the choice relates to watching a movie and/or to listening to music. In an embodiment the choice relates to eating and/or drinking. In an embodiment the recommendation is represented by an advertisement.

Method is provided for outputting a choice recommendation, e.g. related to watching TV programs, to one or more users based on earlier choices made by them, wherein at least one data record is made per choice per user, each data record including a representation of the user, a representation of the choice and a representation of any other user involved with that choice.

In an embodiment the method comprises the steps that

a. a request is made for a recommendation;

b the users present are identified;

c. the watching history is retrieved of all those present;

d. on the basis of one or more weighing methods the watching events in the watching histories of the users present are provided with a weighing factor;

e. all weighed watching events are combined into one common watching history;

f. the combined watching history of weighed watching events is applied to a recommender system;

g. the recommender system makes a recommendation on the basis of the weighed watching events;

h. the recommendation is output.

In an embodiment one of said weighing methods includes assigning a weighing to the watching history on the basis of a binary alone/together situation, where it is detected whether the present watching situation exists from one person or from several persons and, in the case that one person is watching either only watching events are considered where the user watches TV alone, or these watching events are weighed more heavily; where, in the case that several persons watch TV, the watching together watching events are weighed more heavily.

In an embodiment one of said weighing methods includes weighing more heavily watching events where one or several of the present watchers were also present.

In an embodiment one of said weighing methods includes, in particular when users do not have a common watching history, to detect possible common friends and to base the weighing on having or not having common friends.

In an embodiment one of said weighing methods includes detecting and taking in account relation types between the relevant users, e.g. based on data derived from a social network server.

In an embodiment the method is implemented as a software program product which is preferably stored on a tangible carrier.

A system is provided that takes account of the fact that people have different watching demands when they are in a group. Single person profiles are used that have a multi-user component: it records not only what a user has watched, but also who the user has watched this with.

When users have watched content such as news jointly watch events are stored in the profiles of the users. The stored watch event for a user contains a “watched with” field identifying the other user, or users, with which the user watched the content. The identity of users that jointly watch content may be detected by the means described for this purpose in US 2003/237093. This may be done at the location of a TV for example. Then a new watch event for user, i.e. a data record comprising an identification of the content and at least the co-watcher may be created and transmitted to a storage device for the profile. The watch event may be transmitted for example when the users stop joint watching of specific content. A corresponding watch event, or watch events may be created for the co-watcher or co-watchers.

By storing “watched with” information in the profiles of users instead of in profiles of groups the information becomes more useful and more broadly applicable. The information that a user X has watched a program DEF with users Z and V can be used when X later watches with only Z, or with V alone or with Z and V, or with users Z, V and W.

In other words, a data model is used wherein watching history of a user is expanded with information about a person or persons who with the user has watch with jointly. A synchronization protocol is used to update the watching history and to keep it up to date. An algorithm is used to make group recommendations on the basis of the joint watching history.

When a user (“Alice”) requests a recommendation, the system tests whether the user is watching alone or with co-watchers. The presence of co-watchers can be determined with any known method, such as the methods described in US 2003/237093, including the use of login and logoff mechanism for the users, a fingerprint reader panel, a physical push button provided on a display panel, a radio smartcard badge, an inductive badge, a face recognition system, a voice recognition system, one or more individual personal computers of the users, or computing device for example. If the user is watching alone, the history set for the user is retrieved and used to generate a program recommendation. If the user is watching with co-watchers, the identity of the co-watchers is determined (e.g. “Bob” or “Bob and Charlie”) a history set for all of the users is retrieved and used to generate the program recommendation.

In general, in the computation of the recommendation for the current group of users from recorded watch events, more weight is given to watch events that indicate that a user from the current group watched content with one or more co-watchers from the current group.

In an embodiment this may be done by computing a common watching history for the current group from the recorded watch events for users in the current group. Thus, the common watching history is adapted to the composition of current group. Then the computed common watching history can be used to determine a recommendation in a way that is known per se for computing a recommendation from the watching history of a single user. A known collaborative filtering approach, or known a content based approach may be used to compute the recommendation.

As is known per se, a collaborative filtering approach to recommend a content item to a user comprises selecting a matching user or matching users and recommending content items that have received a high score from the matching user(s). The score can be an implicit score, such as a score based on viewing duration by the matching user(s), or an explicit score received from the matching user(s). In known collaborative filtering selection of a matching user or matching users comprises comparing scores given by the user for content items with scores given by potential matching users for the same content items, and selecting those users from the potential matching users that have given the most similar scores. A user match score may be computed for each potential matching user dependent on differences or correlations between scores given for the same content items, potential matching user(s) being selected as matching user(s) dependent on the difference score or the correlations. Potential matching user(s) may be selected dependent on whether their difference score is lower than, or their correlation score is higher than that of any (or all but a predetermined number) of the other potential matching user(s) or potential matching user(s) may be selected dependent on whether the difference score is below or the correlation score is above a threshold. When collaborative filtering is used to provide a recommendation for a group, a synthetic viewing history for the group comprising watch events selected using the “watched with” information may be constructed for use to select the matching user(s). In a further embodiment, contributions to the match score may be weighed dependent on whether the watch events indicate that a user from the current group watched content with one or more co-watchers from the current group.

As is known per se, a content based approach comprises computing a content item match score for a content item from attribute values of the content item weighed with attribute weighing factors from a user profile, content items being recommended based on the content item match score (selecting content items in similar ways as matching users may be selected in the case of collaborative filtering). As is known per se, the attribute weighing factors in the user profile for the user may be determined based on the viewing history, e.g. based on scores for content items given explicitly or implicitly by a user, the scores being based for example on recorded viewing duration by the user of content items with known attribute values. When content item attribute-user profile matching is applied to obtain a recommendation for the group, a synthetic viewing history for the group comprising watch events selected using the “watched with” information may be constructed for use to determine the attribute weighing factors. In a further embodiment, the contributions of different watch events to the computation of attribute weighing factors may be adjusted dependent on whether the watch events indicate that a user from the current group watched content with one or more co-watchers from the current group.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A method for outputting a choice recommendation related to content items, the method comprising:
recording a watching history of users, the watching history comprising representations of watch events, the representation of a watch event for a user including information about a further user or users who with the user has jointly watched a content item;
making a recommendation for a group of users dependent on recorded joint watching of users in the group.

2. The method according to claim 1, further comprising:
receiving a request for the recommendation for a group of users;
retrieving the watching history of all the users of the group;
providing the watching events in the retrieved watching histories each with a weighing factor, dependent on whether the watching event represents that at least part of the users of the group have watched jointly;
combining all weighed watching events into one common watching history;
applying the combined watching history of the weighed watching events to a recommender system;
using the recommender system to make a recommendation on the basis of the weighed watching events; and
outputting the recommendation.

3. The method according to claim 2, wherein the group is determined by identifying users that are present.

4. The method according to claim 2, wherein said providing with the weighing factor includes assigning a weighing to the watching history on the basis of a binary alone/together situation includes the steps of
detecting whether in the present watching situation the group of users consists of one user or a plurality of users and,
in the case that the group consists of one user only watch events are considered that represent that the user has watched TV alone, or these watching events are weighed more heavily than watch events that represent that the user has watched TV with other users; and where,
in the case that the group consists of a plurality of users, watch events that represent that the user has watched TV with other users of the group are weighed more heavily.

5. The method according to claim 2, wherein said providing with the weighing factor includes assigning a heavier weight to the watching events for a first user in the group that represent that where one or several of the other users in the group watched with the first user in the group.

6. The method according to claim 2, wherein said providing with the weighing factor includes, in particular when users of the group do not have watch events representing that they watched with other members of the group, detecting possible common friends and to base the weighing factor on having or not having common friends.

7. The method according to claim 2, wherein said providing with the weighing factor includes detecting and taking in account relation types between the relevant users.

8. A computer program product comprising a program for a computer that, when executed by the processor, causes the computer to execute the method of claim 1.

9. A recommendation system for generating recommendations e.g. related to TV programs, the system comprising:
a memory storing data records recording a watching history of users, the watching history comprising representations of watch events for a user, the representation of a watch event including information about at least one further user who with the user has jointly watched a content item; and
a processor programmed to determine a recommendation for a group of users on the basis of recorded joint watching of users in the group.

10. The system according to claim 9, wherein the processor is programmed to
receive a request for the recommendation for the group of users;
retrieve the watching history of all the users of the group;
provide the watching events in the retrieved watching histories each with a weighing factor, dependent on whether the watching event represents that at least part of the users of the group have watched jointly;
combine all weighed watching events into one common watching history;
apply the combined watching history of the weighed watching events to a recommender system;
use the recommender system to make a recommendation on the basis of the weighed watching events; and
output the recommendation.

11. The system according to claim 9, wherein each data record includes a representation of the user, a representation of a content and a representation of no more than one other user that the user has watched the content with, a plurality of data records including representations of respective other user that the user has watched the content with.

12. The system according to claim 9, wherein at least one of the data records includes a representation of a watching environment wherein the content was watched.

13. The system according to claim 9, wherein at least one of the data records includes a representation of location at which the user watched the content.

14. The system according to claim 9, wherein at least one of the data records includes a representation of at least one of hardware and software used to watch the content.
